(19) United States
(12) Patent Application Publication
(10) Pub. No.: US 2024/0338729 A1
(43) Pub. Date: Oct. 10, 2024

(54) PROMOTION SUPPORT SERVER AND PROMOTION SUPPORT PROCESSING METHOD

(71) Applicant: Toshiba Tec Kabushiki Kaisha, Tokyo (JP)

(72) Inventors: Takashi KADO, Mishima Shizuoka (JP); Takayuki ITO, Kawasaki Kanagawa (JP)

(21) Appl. No.: 18/582,306

(22) Filed: Feb. 20, 2024

(30) Foreign Application Priority Data
Apr. 6, 2023 (JP) 2023-062072

(51) Int. Cl. G06Q 30/0242

(52) U.S. Cl. CPC G06Q 30/0243

(57) ABSTRACT

According to an embodiment, a promotion support server includes a storage unit, a communication interface, and a processor. The processor is configured to acquire promotion results data including a plurality of feature parameters for recipients of a promotion related to a product, identify feature parameters in the plurality of feature parameters that are in a multicore relationship, store the identified feature parameters in the storage unit in association with a product identification, cause a display to display a promotion target setting screen on which feature parameters of a recipient of another promotion related to the product can be set by an operator, and cause the display to display a notification when a designated feature parameter among the feature parameters on the promotion target setting screen is one identified as being in a multicore relationship.

### CROSS-REFERENCE TO RELATED APPLICATION

This application is based upon and claims the benefit of priority from Japanese Patent Application No. 2023-062072, filed Apr. 6, 2023, the entire contents of which are incorporated herein by reference.

### FIELD

Embodiments described herein relate generally to a promotion support server and a promotion support processing method for generating sales promotions.

### BACKGROUND

Companies such as product manufacturers, advertising agencies, or retail stores plan and implement various kinds of sales promotions for products and commodities. In the related art, a technique of analyzing details of a customer and providing a promotion created based on an analysis of the customer's details has been proposed.

The customer may be classified based on parameters or features such as a known or listed hobby or other preferences derived from actions, prior purchases, or the like so that a sales promotion according to a classification can be implemented.

However, generally, when the number of parameters or features increases, the independence of the features/parameters is impaired, and the possibility that some features or parameters will have a high correlation to one another increases. When implementing a promotion directed at a group of customers having similar features/parameters, it may be difficult to identify those features/parameters significantly contributing to a sales result and determine the effect of the implemented promotion.

### BRIEF DESCRIPTION OF THE DRAWINGS

FIG. 1 is a diagram of a promotion support system according to an embodiment.

FIG. 2 is a diagram of a promotion support server according to an embodiment.

FIG. 3 is a diagram illustrating an example of a data configuration of a user management table according to an embodiment.

FIG. 4 is a diagram illustrating an example of a data configuration of a multicore management table according to an embodiment.

FIG. 5 depicts aspects of a promotion support server according to an embodiment.

FIG. 6 schematically illustrates result data generated by a second analysis unit according to an embodiment.

FIG. 7 is a diagram illustrating an example of a target feature setting screen provided by a plan support unit according to an embodiment.

FIG. 8 is a diagram illustrating an example of a plan confirmation screen provided by a plan support unit according to an embodiment.

FIG. 9 is a flowchart of processing executed by a promotion support server according to an embodiment.

FIG. 10 is a flowchart of processing executed by a promotion support server according to an embodiment.

FIG. 11 is a flowchart of processing executed by a promotion support server according to an embodiment.

### DETAILED DESCRIPTION

A data processing apparatus and a data processing method capable of supporting product promotional activity in an improved manner are provided. Improvements relate to providing promotion planners/designers notifications of certain relationships in selectable promotion target parameters of intended recipients.

In general, according to one embodiment, a promotion support server includes a storage unit, a communication interface, and a processor. The processor is configured to: acquire promotion results data for a product, the promotion results including a plurality of feature parameters for recipients of a promotion related to the product; identify feature parameters in the plurality of feature parameters of the promotion results data that are in a multicore relationship; store the identified feature parameters in the storage unit in association with a product identification corresponding to the product; cause a display to display a promotion target setting screen on which feature parameters of a recipient of another promotion related to the product can be set by an operator; and cause the display to display a notification when a designated feature parameter among the feature parameters on the promotion target setting screen is one identified as being in a multicore relationship

Hereinafter, certain example embodiments will be described with reference to the drawings. The present disclosure is not limited to these example embodiments.

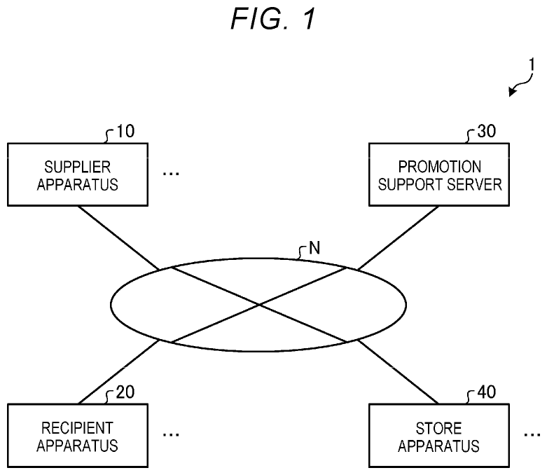

FIG. 1 is a diagram illustrating an example of a configuration of a promotion support system according to an embodiment. As illustrated in FIG. 1, a promotion support system 1 includes a supplier apparatus 10, a recipient apparatus 20, a promotion support server 30, and a store apparatus 40. The supplier apparatus 10, the recipient apparatus 20, and the store apparatus 40 are communicably connected to the promotion support server 30 via a network N such as the Internet. The number of the supplier apparatuses 10, the recipient apparatuses 20, and the store apparatuses 40 connected to the network N is not particularly limited.

The supplier apparatus 10 is an information processing apparatus operated by a supplier that plans a promotion (planned promotion supplier). Examples of a supplier include a manufacturer that manufactures and sells commodities, an advertising agency that produces advertisements and the like, and a retail store that sells commodities or the like. The supplier apparatus 10 transmits promotion information to the promotion support server 30 in response to an instruction from the supplier. The promotion information contents includes promotion plan details. For example, the promotion information includes at least a commodity name (or other identifying information) for a commodity to be promoted in a sales promotion (also referred to as a promotion commodity). The promotion information may also include a promotion implementation period, a promotion implementation method, and the like.

The recipient apparatus 20 is a terminal apparatus operated by a user that may be a promotion recipient (also referred to as a recipient). In the present embodiment, it is assumed that the recipient is a party whose identifier (referred to as a user ID) is registered in the promotion support server 30 by a member registration process or the like. In this context, the user ID is an example of information allowing identification of a parameter of the user.

Examples of the recipient apparatus 20 include a stationary terminal apparatus such as a personal computer (PC), a notebook PC, a tablet terminal, or a smartphone. The recipient apparatus 20 may be a terminal apparatus owned by the recipient or may be installed in a retail store, a restaurant, or the like.

The recipient apparatus 20 stores the user ID of the recipient that presently operates the recipient apparatus 20. In addition, the recipient apparatus 20 sequentially records a history of actions performed by the recipient as an action history.

A method of acquiring the action history is not particularly limited, and various methods can be adopted. For example, the recipient apparatus 20 may store, as the action history, usage contents from an external service (for example, a search site or a social networking service (SNS) site) used via the recipient apparatus 20. The recipient apparatus 20 may record, as the action history, transaction contents of electronic payments performed at a retail store or the like. In addition, the recipient apparatus 20 may record, as the action history, a purchase history of an Internet trading service on an electronic commerce (EC) site or the like.

The recipient apparatus 20 transmits the action history to the promotion support server 30. It is assumed that the action history is transmitted with a corresponding user ID attached so that it is possible to identify the action history as corresponding to a particular recipient.

The promotion support server 30 is an example of a data processing apparatus. The promotion support server 30 collects and analyzes data transmitted from the supplier apparatus(es) 10, the recipient apparatus(es) 20, and the store apparatus(es) 40, and executes processing for supporting implementation of a promotion based on an analysis of the transmitted data.

Although an example in which the promotion support server 30 is implemented as a single server apparatus will be described, embodiments are not limited thereto. For example, the promotion support server 30 may be implemented as multiple server apparatuses by a technique such as cloud computing.

The store apparatus 40 is an information processing apparatus such as a POS terminal or a store server provided in each store. The store apparatus 40 executes various types of processing related to purchases of items sold in the store where the store apparatus 40 is provided. Specifically, each time a transaction is performed, the store apparatus 40 (or a processor therein) generates purchase information indicating transaction contents such as a breakdown (list) of commodities purchased in the transaction. The store apparatus 40 transmits the generated purchase information to the promotion support server 30. When a user ID of a purchaser is input at the time of transaction, the user ID can be included in the purchase information.

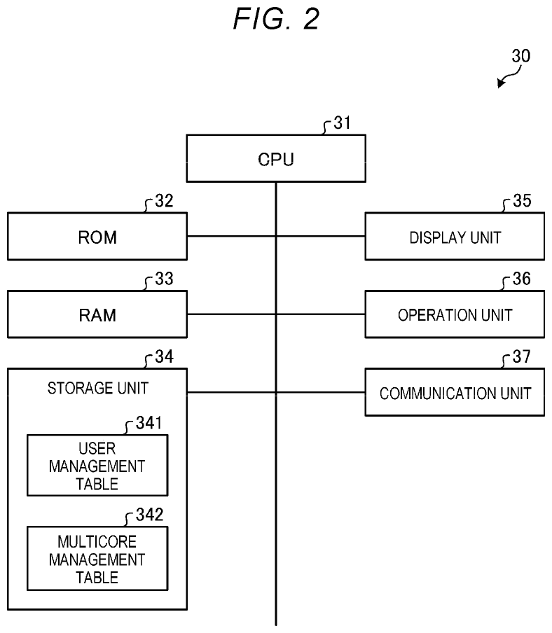

Next, a configuration of the promotion support server 30 will be described. FIG. 2 is a diagram illustrating an example of a hardware configuration of the promotion support server 30. As illustrated in FIG. 2, the promotion support server 30 includes a central processing unit (CPU) 31, a read only memory (ROM) 32, and a random access memory (RAM) 33.

The CPU 31 is an example of a processor, and controls units of the promotion support server 30. The ROM 32 stores various programs. The RAM 33 is a workspace for loading programs and various types of data.

The promotion support server 30 includes a storage unit 34, a display unit 35, an operation unit 36, and a communication unit 37.

The storage unit 34 is implemented as a storage medium such as a hard disk drive (HDD) or a flash memory, and holds stored contents even when the power is cut off. The storage unit 34 stores programs that can be executed by the CPU 31 and various types of setting information. The storage unit 34 functions as a storage area for storing various types of data transmitted from an external apparatus such as a supplier apparatus 10 or a recipient apparatus 20 and a storage area for storing processing results.

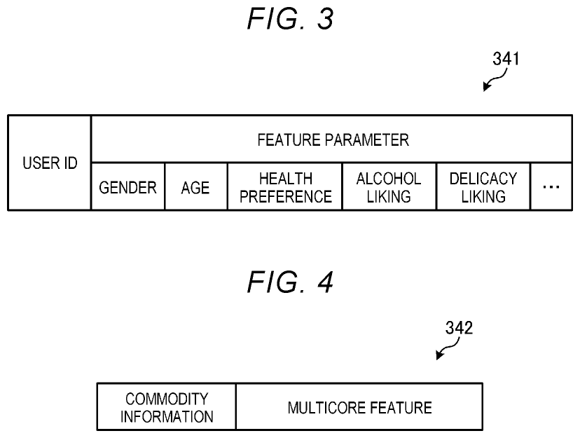

In addition, the storage unit 34 stores a user management table 341 for storing and managing information related to a recipient. FIG. 3 is a diagram illustrating an example of a data configuration of the user management table 341.

As illustrated in FIG. 3, the user management table 341 stores a feature parameter, which indicates a feature (characteristic or attribute) of a recipient corresponding to a user ID, in association with the user ID. The feature parameter can be, for example, attributes of the recipient such as gender and age. The feature parameter may be a preference feature indicating a hobby or other preference of the recipient. The preference features can be set using flag (yes/no) values indicating a presence or absence of characteristics as classified by a predetermined index value for such things as healthy lifestyle, alcohol liking, and delicacy liking. The number of preference features is preferably large in order to permit finely classifying the preferences of the recipient. The preference features may be set by the recipient himself/herself or may be set based on an analysis result from a first analysis unit 312.

The storage unit 34 stores a multicore management table 342 for managing feature parameters of a recipient that are in a multi-colinearity (hereinafter also referred to as multicore) relationship derived based on promotion results of individual commodities. FIG. 4 is a diagram illustrating an example of a data configuration of the multicore management table 342.

As illustrated in FIG. 4, the multicore management table 342 stores a multicore feature in association with certain commodity information. Information related to a commodity is stored in the commodity information. For example, a commodity name, a commodity code, a commodity category, and the like are stored in the commodity information. In the multicore feature, a set of feature parameters in a multicore relationship are stored for the commodity corresponding to the associated commodity information.

Returning to FIG. 2, the display unit 35 includes a display device such as a liquid crystal display (LCD). The display unit 35 displays various types of information under the control of the CPU 31. The operation unit 36 (user input unit) comprises a keyboard, a pointing device, or the like. The operation unit 36 permits a user or operator to provide inputs (e.g., user selections) for CPU 31 operations/processes. The operation unit 36 may be a touch panel provided on a display screen of the display unit 35.

The communication unit 37 is a communication interface connectable to the network N. The communication unit 37 communicates with an external apparatus such as a supplier apparatus 10, a recipient apparatus 20, and/or a store apparatus 40 via the network N.

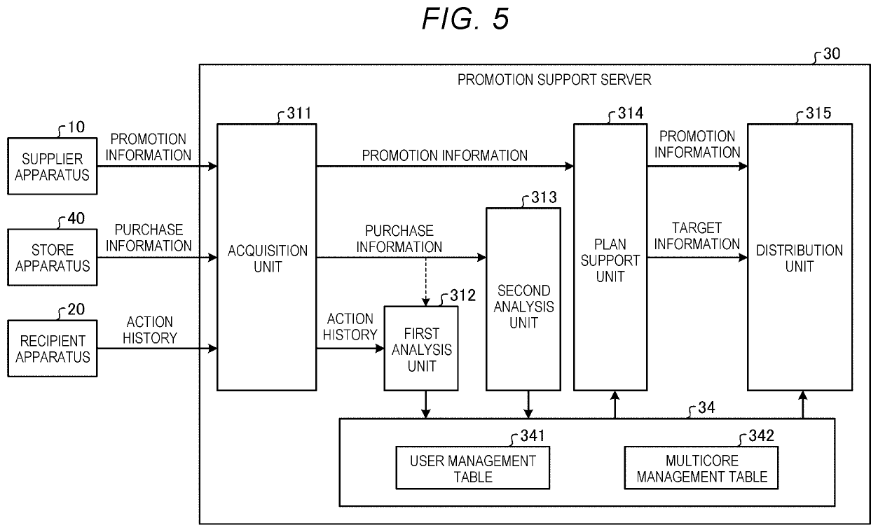

Next, functional aspects of the promotion support server 30 will be described with reference to FIG. 5. FIG. 5 is a diagram for illustrating certain functional aspects of the promotion support server 30.

As illustrated in FIG. 5, the promotion support server 30 provides an acquisition unit 311, the first analysis unit 312, a second analysis unit 313, a plan support unit 314, and a distribution unit 315 as functional units.

A part or all of the functional units (functions) of the promotion support server 30 may be implemented as software program executed by CPU 31. Such a program may be stored in the ROM 32 or the storage unit 34, for example. A part or all of the functional units (functions) of the promotion support server 30 may be implemented as hardware such as a dedicated circuit or the like mounted in the promotion support server 30.

The acquisition unit 311 acquires s (or collects) various types of data transmitted from external apparatuses such as the supplier apparatus 10, the recipient apparatus 20, and the store apparatus 40 via the communication unit 37. Specifically, the acquisition unit 311 acquires promotion information from each supplier apparatus 10. The acquisition unit 311 acquires the action history from each recipient apparatus 20. The acquisition unit 311 acquires the purchase information from each store apparatus 40. The data acquired by the acquisition unit 311 is stored in a storage device such as the storage unit 34.

The first analysis unit 312 determines a preference feature or the like of a recipient by analyzing an action history acquired by the acquisition unit 311. Specifically, the first analysis unit 312 determines presence or absence of a tendency related to each of the various preference features registered in the user management table 341 based on action contents of the recipient included in an action history by using a known technique such as preference analysis. The first analysis unit 312 stores a determination result for the tendency related to each individual preference feature item in the user management table 341 in association with a user ID of the corresponding recipient.

The timing at which the first t analysis unit 312 analyzes the preference features is not particularly limited. For example, action histories acquired by the acquisition unit 311 may be stored in the storage unit 34, and the first analysis unit 312 may perform the above-described processing on any action history acquired within a predetermined period. The first analysis unit 312 may also analyze the preference features by taking the purchase information acquired by the acquisition unit 311 from the store device 40 into consideration (see a dashed arrow in the drawing).

The second analysis unit 313 is an example of a specifying unit, a storage control unit, and a generation unit. The second analysis unit 313 analyzes a relationship between the feature parameters of the recipient with respect to a purchase result based on the purchase information acquired by the acquisition unit 311. Specifically, based on the promotion information to be analyzed, the second analysis unit 313 extracts purchase information including the promoted commodity from the purchase information acquired by the acquisition unit 311. For example, when a promotion period is defined in the promotion information, the second analysis unit 313 extracts purchase information for the promoted commodity from purchase information acquired during the promotion period.

Next, the second analysis unit 313 groups recipients having the same combination of feature parameters. The second analysis unit 313 groups recipients (user IDs) in this manner from each piece of the extracted purchase information and the user management table 341, and generates result data in which purchase results are aggregated for each group (with the same combination of feature parameters). Then, the second analysis unit 313 analyzes the relationship between the feature parameters and the purchase results data.

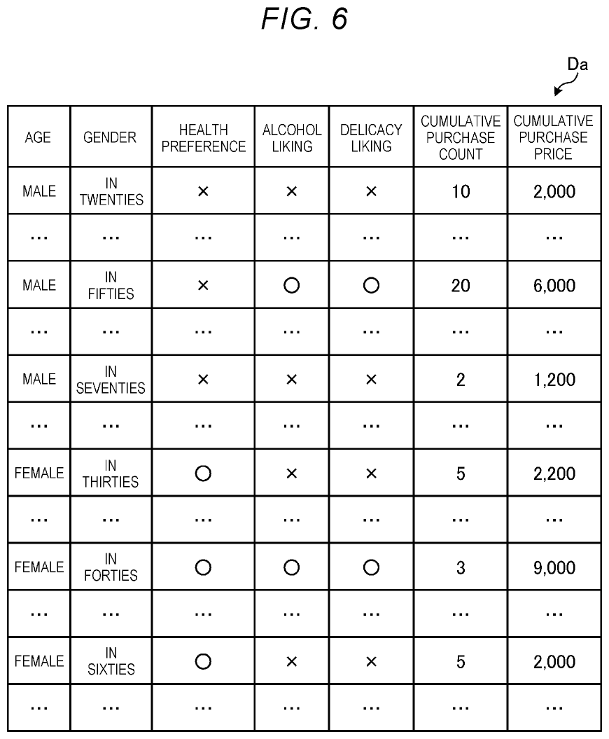

Here, operations of the second analysis unit 313 will be described more particularly with reference to FIG. 6. FIG. 6 is a table schematically illustrating an example of the result data generated by the second analysis unit 313.

As illustrated in FIG. 6, result data Da has a data structure in which a combination of feature parameters indicating features of a recipient is associated with a purchase result for a predetermined commodity. The individual recipients are grouped by matching combinations of feature parameters. Specifically, the result data Da stores purchase results for a predetermined commodity (a promoted commodity to be analyzed) in association with groups classified by a combination of gender, age, and various preference features (e.g., yes/no for health preference, alcohol liking, and delicacy liking).

The purchase result values can be, for example, a cumulative purchase count within a predetermined time period and a cumulative purchase price (total amount spent on buying the commodity) within the predetermined time period. The purchase result may be an average value for the recipients belonging to the group or a total value for the recipients belonging to the group. Further, the predetermined time period related to calculation of the purchase result is preferably a promotion implementation period or the like. The provided purchase results are not limited to a cumulative purchase count or a cumulative purchase price. In addition, in some cases, the purchase result may be provided for a group obtained by randomly selecting recipients (that is, a random sample group having random feature parameters) and included in the result data as a reference.

The more finely the preference features in the feature parameters can be classified, the more finely preferences of a recipient can be set. Therefore, it may be possible to enhance the sales promotion effect by implementing a promotion more finely matching the preferences of recipients. However, when the number of feature parameters is increased, the statistical independence of the individual feature parameters is likely to be impaired, and there is a high possibility that feature parameters having a high correlation (that j feature parameters in a multicore relationship) will be present. When implementing a promotion to the recipient having the feature parameters in a multicore relationship, it can be difficult to perform analysis on the feature parameters contributing to sales and thus to determine the effect of a promotion.

Therefore, the second analysis unit 313 identifies feature parameters in a multicore relationship by applying a known analysis technique such as a multiple regression analysis or an evaluation of multi-colinearity based on the generated result data.

Specifically, the second analysis unit 313 tests a set of feature parameters in each group as an explanatory variable for a purchase result, as an objective variable, and analyzes correlation between these variables. In addition, the second analysis unit 313 analyzes correlation between explanatory variables to identify the feature parameters: in a multicore relationship. Here, the second analysis unit 313 may identify feature parameters in a multicore relationship for some (for example, just the preference features) of the explanatory variables. When the in feature parameters a multicore relationship are identified, the second analysis unit 313 stores these feature parameters in the multicore management table 342 in association with commodity information the commodity being analyzed.

For example, in the case of the result data Da in FIG. 6, the second analysis unit 313 identifies that an “alcohol liking” in a “present” (yes) preference state and a “delicacy liking” in a “present” (yes) preference state are in a multicore relationship. In this case, the second analysis unit 313 stores the “alcohol liking” in a “present” preference state and the “delicacy liking” in a “present” preference state as in a multicore relationship, in the multicore management table 342 in association with the commodity information of the promoted commodity.

Returning to FIG. 5, the plan support unit 314 is an example of a providing unit and a notifying unit. The plan support unit 314 executes processing for supporting implementation of a promotion.

For example, in accordance with an instruction from an operator who designates promotion information, the plan support unit 314 provides the operator with an operation screen (target feature setting screen) on which a feature parameter of a target recipient of promotion can be set. As an example, the plan support unit 314 displays the target feature setting screen on the display unit 35.

In addition, the plan support unit 314 performs notification when the combination of feature parameters designated through the target feature setting screen coincides with a combination of parameters stored in the multicore management table 342.

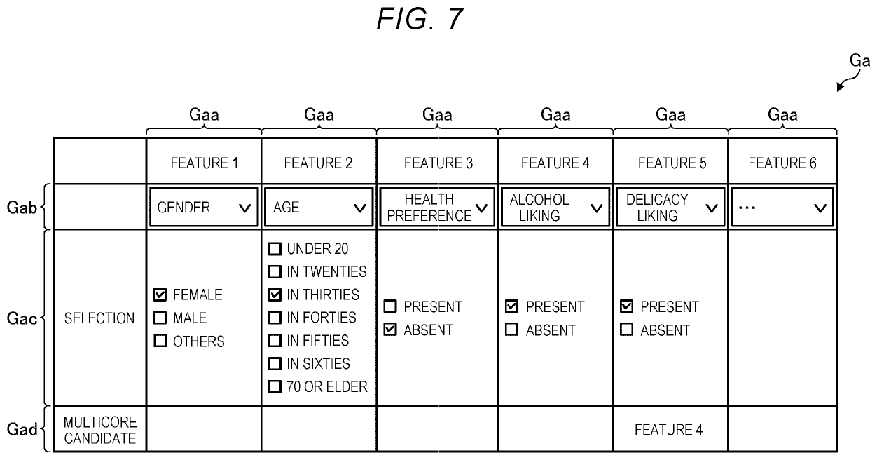

FIG. 7 is a diagram illustrating an example of the target feature setting screen provided by the plan support unit 314. As illustrated in FIG. 7, a target feature setting screen Ga includes six regions Gaa for feature 1 to feature 6 for defining feature parameters of a target recipient. Each region Gaa further includes a first selection region Gab, a second selection region Gac, and a notification region Gad.

Here, the first selection region Gab is a region for designating a feature parameter of the target recipient. For example, selectable attributes and preference features are displayed in a drop-down list format in the first selection region Gab. In this case, the operator can designate the feature parameter of the target recipient by selecting a desired item from the drop-down list. FIG. 7 illustrates an example in which “gender” is selected as feature 1, “age” is selected as feature 2, “health preference” is selected as feature 3, “alcohol liking” is selected as feature 4, and “delicacy liking” is selected as feature 5.

In the second selection region Gac, an option related to the feature parameter selected in the first selection region Gab is displayed. For example, when “gender” is selected in the first selection region Gab, options of “female”, “male”, and “others” are displayed in the second selection region Gac. When “age” is selected in the first selection region Gab, options allowing selection of different ages (age ranges) are displayed in the second selection region Gac. When a feature parameter such as “health preference” is selected in the first selection region Gab, options allowing selection of “present” (yes) and “absent” (no) for the feature parameter state is displayed in the second selection region Gac.

The operator can designate a desired feature parameter via the first selection region Gab and the second selection region Gac described above. In each of the second selection regions Gac, plural options may be selected.

When a combination of feature parameters selected is in a multicore relationship, a message or the like for notifying this fact is displayed in the notification region Gad. Specifically, regarding a promotion commodity related to the setting of the feature parameters, when a combination of feature parameters in a multicore relationship stored in the multicore management table 342 coincides with the combination of feature parameters selected, the plan support unit 314 performs notification via a notification region Gad.

FIG. 7 illustrates that the “alcohol liking”+a “present” state selected in a first selection region Gab and a second selection region Gac of the feature 4 column and the “delicacy liking”+a “present” state selected in a first selection region Gab and a second selection region Gac of the feature 5 column are in a multicore relationship. In this case, as illustrated in FIG. 7, the plan support unit 314 performs notification to the operator by displaying “feature 4” in the notification region Gad of the feature 5 column since the selected feature 4 and the selected feature 5 are in a multicore relationship. Accordingly, the operator can easily understand that features that have been selected include features in a multicore relationship.

A method of notifying the multicore relationship is not limited to the depicted manner. For example, highlighting display change such as changing a background color of the regions Gaa of the feature 4 and the feature 5 may be performed to notify that both features are in a multicore relationship. In addition, the corresponding options (“present” in this example) of the second selection regions Gac may be highlighted by a red font or text or the like to notify the particular options related to the multicore relationship. The target feature setting screen is not limited to the example in FIG. 7. For example, the number of regions Gaa is not limited to six, and a screen configuration in which the number of regions Gaa can be increased or decreased according to an operation of the operator may be adopted.

When a confirmation operation is received from the operator on the target feature setting screen Ga, the plan support unit 314 generates target information defining feature parameters of the target recipient based on the combination of feature parameters selected on the target feature setting screen Ga. The generated target information is stored in the storage unit 34 in association with, for example, corresponding promotion information.

In accordance with an instruction from the operator, the plan support unit 314 provides the operator with an operation screen (plan confirmation screen) on which a target recipient class for the promotion can be confirmed. The plan support unit 314 displays the plan confirmation screen on the display unit 35.

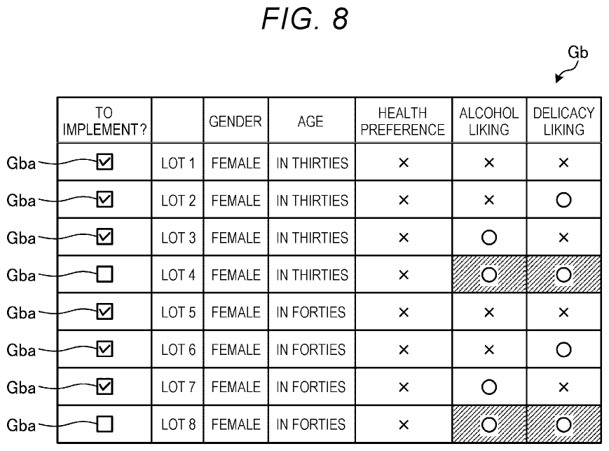

Specifically, the plan support unit 314 displays the plan confirmation screen shown in FIG. 8 on the display unit 35 based on the target information associated with the promotion information.

FIG. 8 is a diagram illustrating an example of the plan confirmation screen provided by the plan support unit 314. As illustrated in FIG. 8, on a plan confirmation screen Gb, the target information set on the previous target feature setting screen Ga is displayed together with a corresponding lot number. FIG. 8 illustrates an example in which eight groupings of target information corresponding to lots 1 to 8 are displayed. The target information of the lot 4 and the lot 8 includes the feature parameters of yes/present for both “alcohol liking” and “delicacy liking,” which are in a multicore relationship as described above.

Here, it is preferable that the plan support unit 314 performs display for notifying (specifying) the feature parameters in a multicore relationship on the plan confirmation screen Gb. Specifically, similarly to the case of the target feature setting screen Ga, regarding a promotion commodity in the designated promotion information, the plan support unit 314 performs notification when a combination of feature parameters in a multicore relationship stored in the multicore management table 342 coincides with a combination of feature parameters defined in the target information.

In this case, the notification method is not particularly limited, and for example, as illustrated in FIG. 8, the notification may be performed by highlighting regions in which the feature parameters in a multicore relationship are displayed. In addition, for example, the plan support unit 314 may perform the notification by highlighting a region for the specific target information (lot number or the like) including the feature parameters in a multicore relationship.

In the plan confirmation screen Gb, a check box Gba for instructing to implement a promotion is provided for each piece (grouping) of target information. The operator can select target information for which a promotion is to be implemented by checking or unchecking the check box Gba. For example, the operator can select target information for which a promotion is to be implemented while avoiding the target information groupings including feature parameters in a multicore relationship.

In addition, when an operation for instructing to implement a promotion is performed when at least one check box Gba is checked, the plan support unit 314 sets the checked target information as an implementation target of the promotion.

Returning to FIG. 5, the distribution unit 315 is an example of an implementation unit. The distribution unit 315 executes a promotion based on the target information set by the plan support unit 314. Specifically, the distribution unit 315 implements a promotion for the promoted commodity defined in the promotion information directed toward a recipient satisfying the condition(s) of the target information set for the implementation.

The promotion implementation method is not particularly limited, and various methods can be adopted. For example, the distribution unit 315 may extract a recipient satisfying the conditions of the target information from the user management table 341 and then distribute a computer message (CM) or text message for the promotion commodity, a discount coupon, or the like to the recipient apparatus 20 of the extracted recipient. The promotion implementation method may be specified in the promotion information in some cases.

When the recipient is interested in the promoted commodity, the recipient can go to a store to purchase the promoted commodity, for example. At the time of sales transactions including the promoted commodity, the store apparatus 40 generates purchase information including the user ID of the purchaser (the promotion recipient). The store apparatus 40 transmits the generated purchase information to the promotion support server 30, and the acquisition unit 311 acquires the purchase information. Accordingly, the purchase information indicating a promotion result is delivered to the second analysis unit 313.

As described above, the promotion support server 30 can support the selection of the target recipient for a promotion and can use implementation results of promotions sent to the selected recipient to identify the recipient again or another recipient for a promotion.

Hereinafter, an example of processing executed by the promotion support server 30 of an embodiment will be described.

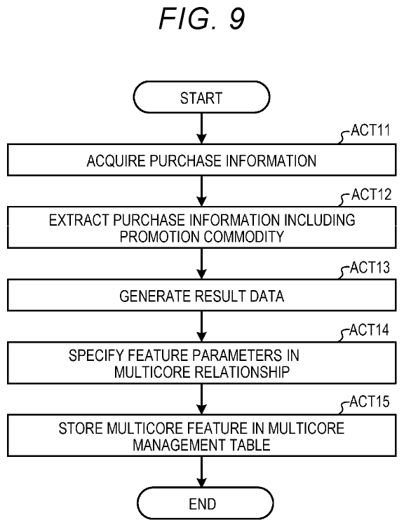

First, processing related to generation of the multicore management table 342 will be described with reference to FIG. 9. FIG. 9 is a flowchart illustrating an example of the processing executed by the promotion support server 30. It is assumed in this example that a feature parameter of each potential recipient is already stored in the user management table 341. It is also assumed that a promotion of a commodity defined in the promotion information may be first performed or sent to a randomly selected recipient or a recipient from within in each group.

First, the acquisition unit 311 acquires purchase information from the store apparatus 40 (ACT 11). The first analysis unit 312 extracts the particular purchase information related to the promoted commodity from the purchase information acquired by the acquisition unit 311 (ACT 12). Next, based on the user IDs included in the extracted purchase information and the user management table 341, the first analysis unit 312 generates result data in which purchase results are aggregated for each group of recipients set by feature parameters (ACT 13).

Subsequently, the first analysis unit 312 analyzes the result data to identify those feature parameters demonstrating a multicore relationship (ACT 14). Then, the first analysis unit 312 associates the feature parameters in a multicore relationship (as specified in ACT 14) with the commodity information of the promoted commodity and stores the identified feature parameters in the multicore management table 342 (ACT 15).

Accordingly, those features of the recipient demonstrating a multicore relationship are stored in the multicore management table 342 for the commodity to be promoted.

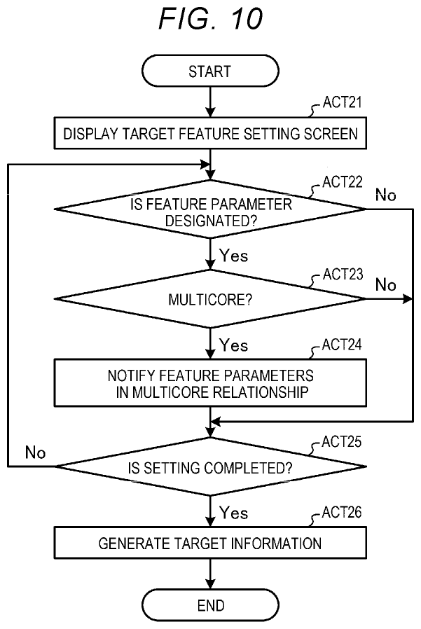

Next, with reference to FIG. 10, processing related to setting of a target recipient class of a promotion will be described. FIG. 10 is a flowchart illustrating an example of processing executed by the promotion support server 30. It is assumed in this examples that feature parameters identified as being in a multicore relationship have already been stored in the multicore management table 342 for the commodity set in the promotion information.

First, when an instruction to start setting of a feature parameter of a target recipient for a promotion is received via the operation unit 36 or the like, the plan support unit 314 displays a target feature setting screen (see FIG. 7) on the display unit 35 (ACT 21).

Next, the plan support unit 314 checks whether a feature parameter designation has been received (ACT 22). Here, when no feature parameter has been designated yet (ACT 22; No), the processing proceeds to ACT 25.

When an operation designating a feature parameter is received (ACT 22; Yes), the plan support unit 314 checks the multicore management table 342 to determine whether a combination of designated feature parameters satisfies a multicore relationship (ACT 23). When the combination does not satisfy a multicore relationship (ACT 23; No), the processing proceeds to ACT 25. If notification in ACT 24 was previously performed, display of the notification is removed, and the processing proceeds to ACT 25.

On the other hand, when the combination of designated parameters satisfies a multicore relationship (ACT 23; Yes), the plan support unit 314 notifies that there is a set of feature parameters in a multicore relationship (ACT 24), and then proceeds to ACT 25.

Next, the plan support unit 314 determines whether a setting completion operation has been received (ACT 25). When the setting completion operation is not received (ACT 25; No), the processing returns to ACT 22. When a setting completion operation is received (ACT 25; Yes), the plan support unit 314 generates target information based on the set of designated feature parameters.

Accordingly, the promotion support server 30 can generate the target information in which the feature parameters of the target recipients of promotion are defined. In addition, when a combination of feature parameters designated by an operator is in a multicore relationship, the promotion support server 30 can notify the operator of the presence of the multicore relationship in the designated feature parameters.

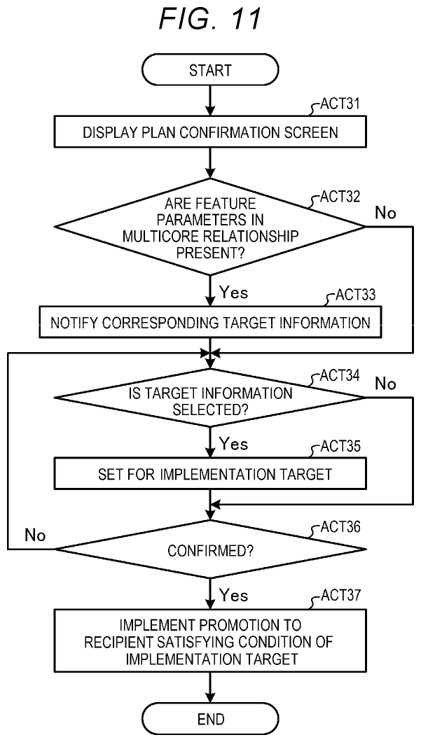

Next, processing related to implementation of a promotion will be described with reference to FIG. 11. Here, FIG. 11 is a flowchart illustrating an example of processing executed by the promotion support server 30. It is assumed in this example that target information in which feature parameters of a target recipient for a promotion are already set for a commodity defined in the promotion information.

First, when the plan support unit 314 receives, via the operation unit 36 or the like, an operation instructing to implement a promotion, the plan support unit 314 displays a plan confirmation screen (see FIG. 8) on the display unit 35 based on target information related to a promotion of an implementation target (ACT 31).

Further, the plan support unit 314 determines, based on the multicore management table 342, whether a set of feature parameters in a multicore relationship is included in the target information (ACT 32). Here, when no set of feature parameters in a multicore relationship is included (ACT 32; No), the processing proceeds to ACT 34. On the other hand, when a set of feature parameters in a multicore relationship is included (ACT 32; Yes), the plan support unit 314 provides a notification for the corresponding target information (ACT 33), and proceeds to ACT 34.

Subsequently, the plan support unit 314 waits (ACT 34; No-ACT 36; No) until target information (for example, a lot number) for implementing a promotion is selected from the plan confirmation screen. When the selection of the target information is received (ACT 34; Yes), the plan support unit 314 sets the selected target information for the implementation target (ACT 35), and proceeds to ACT 36.

In ACT 36, the plan support unit 314 determines whether an operation confirming the implementation target has been performed (ACT 36). Here, when a confirmation operation is not performed (ACT 36; No), the processing returns to ACT 34.

After the confirmation operation is performed in ACT 36 (ACT 36; Yes), the distribution unit 315 implements a promotion to a recipient satisfying a condition of the target information set for the implementation target (ACT 37), and ends the processing. Accordingly, the promotion support server 30 can permit the operator to determine, based on the target information, a group of recipients who are implementation targets of the promotion. In addition, when the target information includes features (parameters) in a multicore relationship, the promotion support server 30 notifies the operator of the presence of those features.

As described above, the promotion support server 30 identifies a set of feature parameters in a multicore relationship based on previous results data in which feature parameters of a recipient are associated with purchase results of a promoted commodity, and stores the identified combination(s) in the multicore management table 342 in association with commodity information of the particular promoted commodity. In addition, the promotion support server 30 provides an operation screen (target feature setting screen) on which a feature parameter of a target recipient of a promotion can be designated, and performs a notification when a combination of feature parameters designated on the operation screen coincides with a combination of feature parameters identified as being in a multicore relationship.

As described above, when the combination of feature parameters designated by an operator is in a multicore relationship, the promotion support server 30 notifies the operator of the presence of the multicore relationship causing the operator to recognize the presence of this issue. Accordingly, the promotion support server 30 can prevent a recipient with identified feature parameters in a multicore relationship from being carelessly set as a promotion target, and can support selection of a target recipient. Accordingly, the promotion support server 30 can support a successful promotions of a commodity.

The above-described embodiment can be modified in various ways. Hereinafter, certain modifications will be described. In the following description, differences from the above-described embodiment will be highlighted, and a detailed description of points common to those already described above may be omitted. The modifications described below may be implemented individually or in combination as appropriate.

### Modification 1

Although the implementation result (result data) of a promotion is acquired from purchase information in the above-described embodiment, the present disclosure is not limited thereto. The result data may be acquired from various other types of information.

For example, the result data may be acquired from an action history acquired from the recipient apparatus 20. In this case, the implementation results for a promotion may be derived using an index other than the purchase result. For example, the number of retrievals of a webpage or the like for the promoted commodity, the number of posts (reference number) on a SNS related to the promoted commodity, or the like may be derived as an implementation result of a promotion.

In examples, some information indicating an implementation result of a promotion may be acquired from an external research agency or the like. In this context, examples of possible research agencies also include a manufacturer that manufactures and sells products, an advertising agency that produces advertisements and the like related to products, and a retail store that sells products.

The implementation result of a promotion may include, for example, information indicating a commodity (a promoted commodity) targeted in the promotion, a user ID of a recipient of the promotion who purchased the commodity, a sales result (sales data), and the like. In addition, the implementation result of a promotion may breakdown a sales result by features or groups of features commodity purchasers during a predetermined period of time covering the implementation period of the promotion. The method of collecting the implementation result of a promotion is not particularly limited, and any known technique may be used.

### Modification 2

Although the second analysis unit 313 identifies the feature parameters in a multicore relationship from results data in the above-described embodiment, the present disclosure is not limited thereto. For example, the second analysis unit 313 may also identify a feature parameter having relatively high independence in the contribution to an objective variable, together with the feature parameters in a multicore relationship, and store the feature parameters in the multicore management table 342.

In this case, the plan support unit 314 may perform notification to the operator by displaying the high independence feature parameter in a highlighted manner on a target feature setting screen or a plan confirmation screen. The plan support unit 314 may be able to automatically set a feature parameter contributing to the objective variable on the target feature setting screen.

The programs executed by the apparatuses of the above-described embodiment can be provided by being incorporated in advance in a ROM, a storage unit, or the like or by being recorded in a computer-readable recording medium such as a CD-ROM, a flexible disk (FD), a CD-R, or a digital versatile disk (DVD) as a file in an installable or executable format.

Furthermore, the programs executed by the apparatuses of the above-described embodiments may be provided by being stored in a computer connected to a network such as the Internet and downloaded via the network. The programs executed by the apparatuses of the above-described embodiment may be provided or distributed via a network such as the Internet.

While certain embodiments have been described, these embodiments have been presented by way of example only and are not intended to limit the scope of the disclosure. These novel embodiments and modifications thereof can be implemented in various other forms, and various omissions, replacements, and modifications can be made without departing from the gist of the disclosure. The embodiments and the modifications thereof are included in the disclosure, and are included in a scope of the claims and equivalents thereof.

What is claimed is:

1. A promotion support server, comprising:
a storage unit;
a communication interface; and
a processor configured to:
acquire promotion results data for a product, the promotion results including a plurality of feature parameters for recipients of a promotion related to the product;
identify feature parameters in the plurality of feature parameters of the promotion results data that are in a multicore relationship;
store the identified feature parameters in the storage unit in association with a product identification corresponding to the product;
cause a display to display a promotion target setting screen on which feature parameters of a recipient of another promotion related to the product can be set by an operator; and
cause the display to display a notification when a designated feature parameter among the feature parameters on the promotion target setting screen is one identified as being in a multicore relationship.

2. The promotion support server according to claim 1, wherein the processor is further configured to:
receive purchase information for the product via the communication interface, the purchase information including information allowing specification of the feature parameters of a purchaser who purchased the product; and
generate the promotion result data from the purchase information.

3. The promotion support server according to claim 2, wherein the purchase information includes an identifier allowing identification of the purchaser.

4. The promotion support server according to claim 3, wherein the promotion results data is extracted from the purchase information using identifiers of purchasers in the purchase information.

5. The promotion support server according to claim 2, wherein the processor is further configured to:
cause a promotion to be sent to recipients with feature parameters matching those designated on the promotion target setting screen.

6. The promotion support server according to claim 1, wherein the feature parameters include demographic parameters of promotion recipients.

7. The promotion support server according to claim 1, wherein the notification includes a highlighting of a region on the promotion target setting screen in which the feature parameters identified as being in a multicore relationship are displayed.

8. The promotion support server according to claim 1, wherein the notification includes a text message displayed on the promotion target setting screen.

9. A promotion support processing method, comprising:
acquiring promotion results data for a product, the promotion results including a plurality of feature parameters for recipients of a promotion related to the product;
identifying feature parameters in the plurality of feature parameters of the promotion results data that are in a multicore relationship;
storing the identified feature parameters in the storage unit in association with a product identification corresponding to the product;
causing a display to display a promotion target setting screen on which feature parameters of a recipient of another promotion related to the product can be set by an operator; and
causing the display to display a notification when a designated feature parameter among the feature parameters on the promotion target setting screen is one identified as being in a multicore relationship.

10. The method according to claim 9, further comprising:
receiving purchase information for the product via a communication interface, the purchase information including information allowing specification of the feature parameters of a purchaser who purchased the product; and
generating the promotion result data from the purchase information.

11. The method according to claim 10, wherein the purchase information includes an identifier allowing identification of the purchaser.

12. The method according to claim 11, wherein the promotion results data is extracted from the purchase information using identifiers of purchasers in the purchase information.

13. The method according to claim 10, further comprising:
causing a promotion to be sent to recipients with feature parameters matching those designated on the promotion target setting screen.

14. The method according to claim 9, wherein the feature parameters include demographic parameters of promotion recipients.

15. The method according to claim 9, wherein the notification includes a highlighting of a region on the promotion target setting screen in which the feature parameters identified as being in a multicore relationship are displayed.

16. The method according to claim 9, wherein the notification includes a text message displayed on the promotion target setting screen.

17. A non-transitory, computer-readable medium storing program instructions which when executed by a promotion support server to perform a method comprising:
acquiring promotion results data for a product, the promotion results including a plurality of feature parameters for recipients of a promotion related to the product;
identifying feature parameters in the plurality of feature parameters of the promotion results data that are in a multicore relationship;
storing the identified feature parameters in the storage unit in association with a product identification corresponding to the product;
causing a display to display a promotion target setting screen on which feature parameters of a recipient of another promotion related to the product can be set by an operator; and
causing the display to display a notification when a designated feature parameter among the feature parameters on the promotion target setting screen is one identified as being in a multicore relationship.

18. The medium according to claim 17, the method further comprising:
receiving purchase information for the product via a communication interface, the purchase information including information allowing specification of the feature parameters of a purchaser who purchased the product; and
generating the promotion result data from the purchase information.

19. The medium according to claim 18, wherein the purchase information includes an identifier allowing identification of the purchaser.

20. The medium according to claim 18, the method further comprising:
causing a promotion to be sent to recipients with feature parameters matching those designated on the promotion target setting screen.
